(19) United States
(12) Patent Application Publication
(10) Pub. No.: US 2002/0140672 A1
(43) Pub. Date: Oct. 3, 2002

(54) Computer cursor movement controlling device

(76) Inventor: A-Man Hung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/822,242

(22) Filed: Apr. 2, 2001

(51) Int. Cl. G09G 5/08

(52) U.S. Cl. 345/157

(57) ABSTRACT

A cursor movement controlling device includes a movable portion, such as a regular computer mouse, with a control circuit arranged therein. The control circuit includes a microprocessor and an array of transmitter-receiver pairs electrically connected to the microprocessor. An electrical signal is selectively applied to each transmitter by the microprocessor to generate a magnetic field which in turn induces an electrical signal in each receiver. The induced signal is then applied to the microprocessor. A support pad has top and bottom layers with a plurality of magnetically conductive elements fixed therebetween. The movable portion is movable on the top layer of the support pad whereby the electrical signal induced in each receiver is changed by the magnetically conductive elements when the movable portion is moving on the support pad. The microprocessor is programmed to determine a moving vector and coordinate movement control data for controlling the movement/position of a computer cursor by means of the change of the signals induced in the receivers.

### FIELD OF THE INVENTION

The present invention generally relates to a computer peripheral device, and in particular to a device for controlling the movement of cursor displayed on computer display screen.

### BACKGROUND OF THE INVENTION

Controlling and moving a cursor on a computer display screen is an important means for computer operation. Most commercial software utilizes cursor movement to control computer operations. Examples of conventional devices for controlling computer cursor include computer mice, digitizers, tracking balls and so on.

Mechanical mice and tracking balls require a moving part, such as rotatable sphere, cooperating with an optic encoding device to generate signals corresponding to the movement and/or position thereof. During the operation of the mechanical mice and the tracking balls, debris and dust may be attached to the sphere, leading to deterioration of the performance thereof. Furthermore, the optic encoding device is arranged inside the casing of the mouse. This increases the size of the mouse.

Some of the computer mouse systems include a pad in which a complicated circuit is arranged for detecting the position of the mouse with respect thereto. Examples are Taiwan Patent Publication Nos. 374465 and 397230. The pad must be connected to a computer by a cable. This limits the maneuverability of the mouse system and increases the costs.

The digitizers which is also commonly used to controlling the movement/position of a computer cursor, need a table including a complicated circuit therein for sensing the position of a stylus moving along the table surface. Both the table and the stylus require power supply. This complicates the structure of the digitizers and increases costs thereof

It is thus desirable to provide a computer cursor movement controlling device for overcoming the above problems.

### SUMMARY OF THE INVENTION

Accordingly, an object of the present invention is to provide a computer cursor movement controlling device having a simple and low cost control circuit.

Another object of the present invention is to provide a computer cursor movement controlling device comprising no moving part so as to eliminate the negative effect caused by deposition of dust.

A further object of the present invention is to provide a computer cursor movement controlling device which is operable by moving on a pad without a complicated circuit formed in the pad.

Yet a farther object of the present invention is to provide a computer cursor movement controlling device which determines a relative position thereof with respect to a pad by means of change of magnetic field.

To achieve the above objects, in accordance with the present invention, there is provided a cursor movement controlling device comprising a movable portion, such as a regular computer mouse, with a control circuit arranged therein. The control circuit comprises a microprocessor and an array of transmitter-receiver pairs electrically connected to the microprocessor. An electrical signal is selectively applied to each transmitter by the microprocessor to generate a magnetic field which in turn induces an electrical signal in each receiver. The induced signal is then applied to the microprocessor. A support pad has top and bottom layers with a plurality of magnetically conductive elements fixed therebetween. The movable portion is movable on the top layer of the support pad whereby the electrical signal induced in each receiver is changed by the magnetically conductive elements when the movable portion is moving on the support pad. The microprocessor is programmed to determine a moving vector and coordinate movement control data for controlling the movement/position of a computer cursor by means of the change of the signals induced in the receivers.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a cursor movement controlling device constructed in accordance with the present invention;

FIG. 2 is a diagram of a control circuit of the cursor movement controlling device of the present invention;

FIG. 3 is a top view of a portion of a printed circuit board of the cursor movement controlling device in accordance with the present invention showing a transmitter-receiver pair of the device;

FIG. 4 is a bottom view of FIG. 3;

FIG. 5 is a side elevational view of the cursor movement controlling device of the present invention;

FIG. 6 schematically shows a signal generated by the transmitter; and

FIG. 7 schematically shows a signal induced in the receiver.

### DETAILED DESCRIPTION OF THE PREFERRED EMBODIMENT

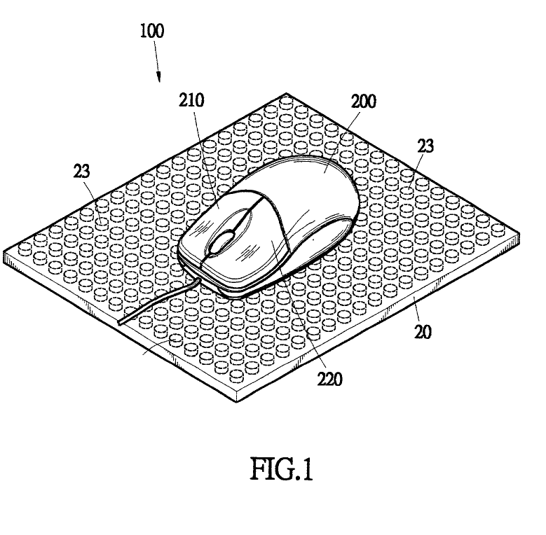

With reference to the drawings and in particular to FIG. 1, a computer cursor movement controlling device constructed in accordance with the present invention, generally designated with reference numeral 100, is shown. The computer cursor movement controlling device 100 comprises a movable portion 200 slidably positioned on a support pad 20. In the embodiment illustrated, the movable portion 200 of the computer cursor movement controlling device 100 is embodied in the form of a computer mouse comprising a casing (not labeled) having a flat bottom movably supported on the support pad 20. Similar to a regular computer mouse, two pushbuttons 210, 220 are formed on the casing of the mouse 200 for user's actuation. A control circuit 10, preferably in the form of a printed circuit board, is arranged and fixed inside the mouse 200 for determining relative positional relationship between the mouse 200 and the support pad 20.

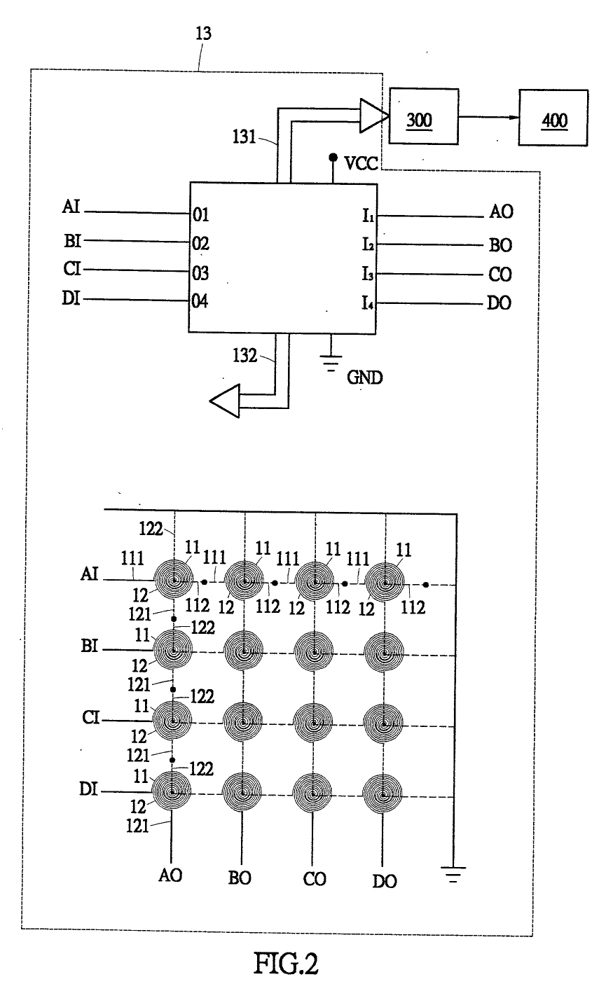

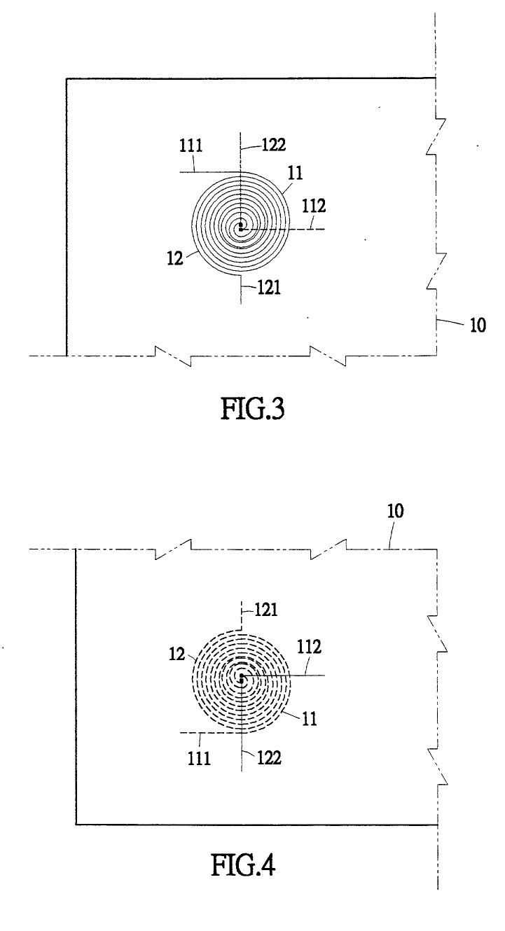

Also referring to FIG. 2, the control circuit 10 comprises a circuit board substrate having top and bottom faces (not labeled). Conductive patterns are printed on at least the bottom face of the circuit board substrate. The conductive patterns include a plurality of signal transmitters 11 and a plurality of signal receivers 12. Both the transmitters 11 and the receivers 12 are formed as coils on the circuit board and each transmitter 11 is inter-wound with a corresponding receiver 12 as shown in FIGS. 2-4 thereby forming a plurality of transmitter-receiver pairs.

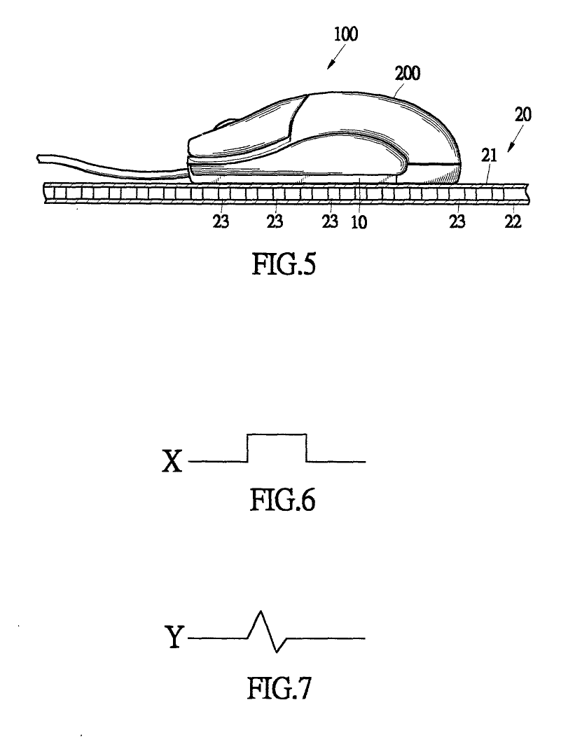

Each transmitter 11 has an input terminal 111 for receiving an electrical signal from a microprocessor 13 (FIG. 2) and a grounding terminal 112. When an electrical signal, such as a pulse, a step wave or a square wave (signal X of FIG. 6), is applied to the transmitter 11 via the input terminal 111, a magnetic field is generated in the transmitter 11 forming magnetic flux. The magnitude of the magnetic field is dependent upon the electrical signal.

Each receiver 12 has an output terminal 121 connected to the microprocessor 13 and a grounding terminal 122. When a magnetic field is generated through the receiver 122, an electrical signal (signal Y of FIG. 7) is induced in the receiver 12 and is then applied to the microprocessor 13. The electrical signal induced in the receiver 12 is dependent upon the magnetic field.

In the embodiment illustrated, the transmitter-receiver pairs (11, 12) are arranged in an array. An example of a four by four array is shown in FIG. 2. All the transmitters 11 of the array are interconnected whereby the input terminals 111 are connected together in four groups respectively connected and forming four input buses AI, BI, CI and DI. Similarly, all the receivers 12 of the array are interconnected whereby the output terminals 112 are connected together in four groups forming four output buses AO, BO, CO and DO. Preferably, all the grounding terminals 112 and 122 of the transmitters 11 and the receivers 12 are commonly grounded.

The control circuit 10 further comprises a microprocessor 13 including output buses O1, O2, O3 and O4 respectively connected to the input buses AI, BI, CI and DI of the transmitter-receiver array for applying electrical signals to the transmitters 11. The microprocessor 13 also includes input buses I1, I2, I3 and I4 respectively connected to the output buses AO, BO, CO and DO of the transmitter-receiver array for receiving the electrical signals induced in the receivers 12. The microprocessor 13 is programmed to determine a moving vector and coordinate movement control data for controlling the movement of the cursor by applying suitable signals to the transmitters 11 and receiving corresponding electrical signals induced in the receivers 12. The calculation and determination of the moving vector and the coordinate movement control data can be done by those having ordinary skill in the art. Thus no further detail regarding to the calculation and determination will be given herein.

The microprocessor 13 further comprises an output interface bus 131 and a pushbutton control bus 132. The output interface bus 131 is coupled to an interface circuit 300 for transmission of the moving vector and the coordinate movement control data to a computer 400. The transmission may be done wirelessly or by means of a connection cable (not shown). The pushbutton control bus 132 is connected to the pushbuttons 210, 220 of the casing 200 for receiving signals corresponding to actuation of the pushbuttons 210, 220. Corresponding signals are applied to the computer 400 via the interface circuit 300.

The support pad 20 has top and bottom layers 21, 22 sandwiching a plurality of magnetically conductive elements 23 therebetween. The magnetically conductive elements 23 may assume any suitable forms and materials, such as cylindrical iron bars. Preferably, each cylindrical element 23 has a central axis arranged to be substantially perpendicular to the top and bottom layers 21, 22 of the support pad 20. In an embodiment of the present invention, the circuit board substrate of the control circuit 10 is arranged parallel to the flat bottom of the casing of the mouse 200, preferably proximate to the flat bottom, whereby the central axes of the cylindrical elements 23 are substantially perpendicular to the circuit board substrate of the control circuit 10.

In operation, the movable portion 200 of the cursor movement controlling device 100 is placed on the support pad 20 with the flat bottom thereof contacting or proximate the top layer 21 of the support pad 20. At the beginning of the operation, the microprocessor 13 applies electrical signals to the transmitters 11 to selectively cause each transmitter 11 to generate an output signal which is then detected by receivers 12. An input signal is then induced in the receivers 12 serving as a reference input signal.

When the movable portion 200 of the cursor movement controlling device 100 is being moved, the microprocessor 13 continuously applies electrical signals to the transmitters 11 to cause output signals which induce input signals in the receivers 12. Due to the presence of the magnetically conductive elements 23, the input signals induced in the receivers 12 change from time to time when the movable portion 200 of the cursor movement controlling device 100 is in movement. As mentioned previously, the input signals are applied to the microprocessor 13 and the microprocessor 13 determines the moving vector and the corresponding coordinate data, a corresponding signal for controlling the position of the computer cursor may then be transmitted to a computer to which the cursor movement controlling device 100 is connected to determine and control the movement and position of a cursor shown on a display screen of the computer.

To this point, it is understood that the present invention possesses the following advantages:

(1) Since no moving part, such as the rotatable sphere, is included in the cursor movement controlling device 100, deterioration of performance caused by debris or dust attached to the moving part is completely eliminated. The performance can thus be enhanced.

(2) Since no moving part (the rotatable sphere) or optic encoding device or complicated circuit is needed, the structure of the cursor movement controlling device of the present invention is simple, thus substantially reducing costs thereof.

(3) No electrical coupling between the support pad 20 and a computer is needed. This simplifies the structure of the cursor movement controlling device of the present invention and reduces costs thereof.

(4) Since there is no moving part (the rotatable sphere), the design of the cursor movement controlling device is simplified and the size is reduced.

Although the present invention has been described with reference to the preferred embodiment thereof, it is apparent to those skilled in the art that a variety of modifications and changes may be made without departing from the scope of the present invention which is intended to be defined by the appended claims.

What is claimed is

1. A cursor movement controlling device comprising:
a movable portion comprising a control circuit comprising a microprocessor and an array of transmitter-receiver pairs electrically connected to the microprocessor whereby a first signal is selectively applied to each transmitter by the microprocessor to generate a magnetic field and whereby a second signal is induced in each receiver by the magnetic field, the second signal being applied to the microprocessor; and
a pad having top and bottom faces with a plurality of magnetically conductive elements sandwiched between the top and bottom faces, the movable portion being movable on the top face of the pad whereby the second signal induced in each receiver by the magnetic field is changed by the magnetically conductive elements;
wherein the microprocessor is programmed to determine a cursor movement signal corresponding to the movement of the movable portion by means of the change of the second signal.

2. The cursor movement controlling device as claimed in claim 1, wherein the control circuit is embodied in a printed circuit board, the transmitters and the receivers comprising coils printed on the printed circuit board.

3. The cursor movement controlling device as claimed in claim 1, wherein the transmitters and the receivers are coils.

4. The cursor movement controlling device as claimed in claim 1, wherein each transmitter comprises an input terminal connected to the microprocessor and a first grounding terminal, each receiver comprising an output terminal connected to the microprocessor and a second grounding terminal, the first and second grounding terminals being grounded.

5. The cursor movement controlling device as claimed in claim 4, wherein the input terminals of the transmitters are connected in groups and wherein the output terminals of the receivers are connected in groups.

6. The cursor movement controlling device as claimed in claim 5, wherein the microprocessor comprises output buses respectively connected to the groups of the input terminals of the transmitters and input buses respectively connected to the groups of the output terminals of the receives.

7. The cursor movement controlling device as claimed in claim 1, wherein the first signal comprises a step signal.

8. The cursor movement controlling device as claimed in claim 1, wherein the first signal comprises a square signal.

9. The cursor movement controlling device as claimed in claim 1, wherein the movable portion comprises a casing movably supported on the pad, the control circuit being enclosed in the casing.

10. The cursor movement controlling device as claimed in claim 9, wherein pushbuttons are formed on the casing and electrically connected to pushbutton control bus of the microprocessor.

11. The cursor movement controlling device as claimed in claim 1, wherein the control circuit is adapted to connect to a computer via an interface circuit for transmitting the cursor movement signal to the computer.

12. The cursor movement controlling device as claimed in claim 11, wherein the microprocessor comprises an output interface bus adapted to connect to the interface circuit.

13. The cursor movement controlling device as claimed in claim 1, wherein the pad comprises a top layer forming the top face and a bottom layer forming the bottom face, the magnetically conductive elements being fixed between the top and bottom layers.

14. The cursor movement controlling device as claimed in claim 1, wherein the magnetically conductive elements comprise cylindrical iron bars.
